(19) United States
(12) Patent Application Publication
(10) Pub. No.: US 2009/0029654 A1
(43) Pub. Date: Jan. 29, 2009

(54) Using radio frequency transmit/receive switches in radio frequency communications

(76) Inventors: Chang-Tsung Fu, Taiwan (TW); Adil Kidwai, Hillsboro, OR (US); Stewart S. Taylor, Beaverton, OR (US); Jonathan C. Jensen, Portland, OR (US)

Correspondence Address: TROP PRUNER & HU, PC, 1616 S. VOSS ROAD, SUITE 750, HOUSTON, TX, 77057-2631, US

(21) Appl. No.: 11/880,595

(22) Filed: Jul. 23, 2007

(51) Int. Cl. H04B 1/44

(52) U.S. Cl. 455/83

(57) ABSTRACT

A metal oxide semiconductor radio frequency transmit/receive switch may enable lower costs and smaller size. The switch uses an inductor and a capacitor circuit to isolate the power amplifier from the low noise amplifier. Metal oxide semiconductor switches are utilized to switch between transmit and receive modes.

### BACKGROUND

This relates generally to transceivers for radio frequency communications.

A transceiver allows both transmission and reception of radio frequency signals. Generally, this bidirectional traffic is facilitated by a radio frequency transmit/receive switch. The switch switches between transmission and reception using the same antenna. In transmission, the signal to the antenna comes from a power amplifier (PA). In reception, the antenna feeds a low noise amplifier (LNA).

Radio frequency transmit/receive switches may be made with gallium arsenide metal-semiconductor field effect transistor (MESFETs) or Pseudomorphic High Electron Mobility Transistor (PHEMT) devices with superior performance using semi-insulating substrates with high quality passive elements and substrate vias to ground. These devices may have relatively high (greater than 1.5 volts) breakdown voltages in such applications.

The power amplifier may have relatively high voltage swings, suggesting the use of transistors in series with the antenna node, with large voltage standoffs or voltage blocking. Typically, such transistors may be gallium arsenide MESFETs and PHEMT devices with higher breakdown voltages. The higher breakdown voltage devices have higher on resistance. The losses due to higher on resistance hurt the noise figure and sensitivity of the receiver and the low noise amplifier, in particular.

### BRIEF DESCRIPTION OF THE DRAWINGS

FIG. 1 is a circuit schematic for one embodiment of the present invention; and

FIG. 2 is a more detailed circuit schematic for another embodiment of the present invention.

### DETAILED DESCRIPTION

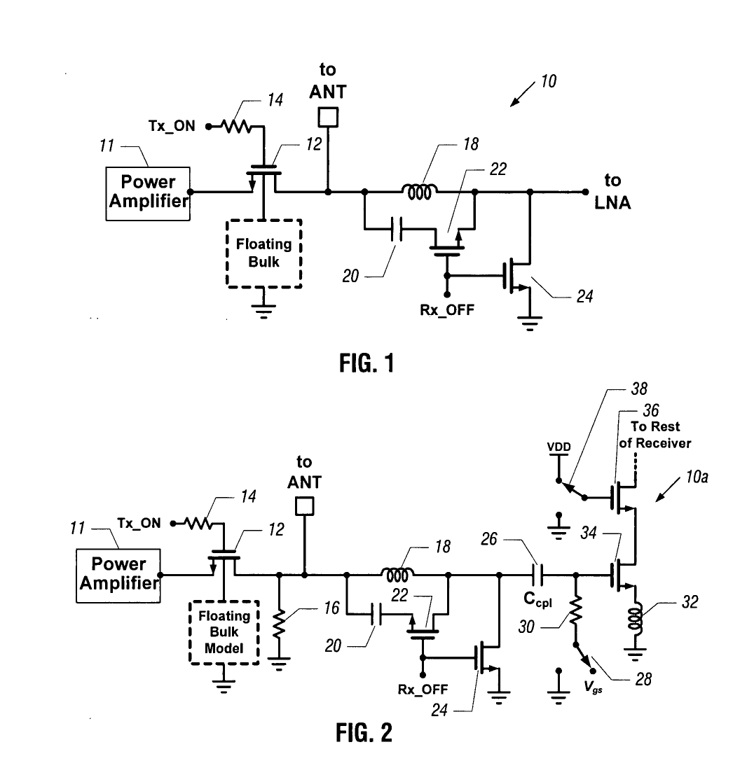

Referring to FIG. 1, a power amplifier 11 is coupled to a radio frequency transmit/receive switch 10. The switch 10 is coupled to an antenna through an antenna node (to ANT) and to a low noise amplifier (to LNA). The transceiver may be part of a mobile radio, a cellular telephone, or a personal computer, to mention a few examples.

The radio frequency transmit/receive switch 10 includes a pass transistor 12 and a parallel resonant circuit including an inductor 18, a capacitor 20, and transistors 22 and 24. The inductor 18 is in parallel with the capacitor 20 that is in series with the transistor 22. The parallel resonant network is in series with a low noise amplifier (LNA) and receiver (not shown in FIG. 1). Neither of the transistors 22 or 24 is in the series path to the low noise amplifier when the low noise amplifier is operational.

All of the transistors may be made with complementary metal oxide semiconductor (CMOS) technology, in one embodiment. In such case, each of the transistors may be an n-channel metal oxide semiconductor field effect transistor (MOSFET). However, in some embodiments, other technologies may be used to form switches, including gallium arsenide MESFET or PHEMT technologies.

The inductor 18 may be the input matching inductor for the low noise amplifier (LNA). This use of the inductor 18, as both a switch and a matching element, avoids the need for additional elements that would otherwise require additional die area and would result in additional losses.

In the transmission mode, the voltage on the nodes Tx_ON and Rx_OFF is high, turning on the transistors 12, 22, and 24. With the transistor 22 on, the inductor 18 resonates with the capacitor 20 at a specified frequency to form a high impedance, isolating the antenna node (to ANT) from the LNA input (to LNA).

The transistor 24 is also turned on or in low impedance, acting as a shunt switch. The transistor 24 provides additional attenuation and isolation at the LNA input node which the transistor 24 pulls to ground. If any signal leaks through the parallel resonant circuit, it is attenuated by the switch 24. Together, the parallel resonant circuit and transistor 24 form a voltage divider that acts as an attenuator.

The required voltage standoff of transistors 22 and 24 may be small in some embodiments. This small stand off enables the use of short gate length low voltage (i.e., about 1.5 volts or less) devices, which have lower on-resistance and use less die area.

The transistor 12 may be a pass transistor for the power amplifier (PA) 11 in the transmit mode, whose reliability and linearity may be ensured by using a large gate resistor 14 and floating/remote bulk connection, as indicated, in some embodiments. This may make the AC voltage on the gate of the transistor 12 and the bulk nodes bootstrapped to the voltage on the source and drain nodes of the transistor 12. The transistor 12 may also be a MOSFET transistor. The transistor 12 may have body contacts that are spaced away from the transistor to form remote body contacts or a floating bulk. The transistors 12, 20, and 24 may be low voltage MOSFET devices having breakdown voltages on the order of 1.5 volts or less and generally of the same magnitude as the supply voltage.

The resulting peak power handling capability may be 20 dBm in some embodiments. The simulated insertion loss in the transmit mode may be about 0.4 dB in some embodiments.

In the receive mode, the voltage on nodes Tx_ON and Rx_OFF is low, turning off the transistors 12, 22, and 24. Thus, there may be no significant losses between the antenna and the low noise amplifier input. Simulated insertion loss and increased noise figure for this embodiment may be 0.1 dB. This is much less and in sharp contrast to conventional radio frequency switches that typically have a series transistor between the low noise amplifier input and the antenna, which have much greater insertion loss, typically on the order of 1 dB.

Referring to FIG. 2, a transceiver includes both the switch 10 and the low noise amplifier 10a. The floating/remote bulk connection for the transistor 12 is chosen by developing an equivalent model of the substrate from field simulations for various layout conditions. The low noise amplifier design and tuning may be similar to a conventional source degenerated, series-tuned cascode amplifier.

The low noise amplifier includes the transistors 34 and 36, a resistance 30, switches 28 and 38, a capacitor 26, and an inductor 32. When the LNA 10a is off, switches 28 and 38 are set to ground to disable transistors 34 and 36, achieving greater isolation. The transistors 34 and 36, as well as the switches 28 and 38, may be NMOS transistors in a CMOS technology in one embodiment. The drain of the transistor 36 may be coupled to the rest of the receiver section that may include another amplifier stage or mixer, as two examples.

When the LNA 10a is off, it is preferable that it does not draw current. If the gate of transistor 34 is DC coupled to ground by the switch 28, then the drain current of the transistor 34 should be essentially zero. Connecting the gate of transistor 36 to ground helps to ensure that the whole chain of transistors 34 and 36 does not conduct or pass any signal when the switch 10 is in the transmit mode.

The capacitor 26, between the parallel resonant network and the low noise amplifier 10a, provides DC blocking. It is also part of a matching network of the low noise amplifier 10a, in one embodiment.

In some embodiments of the present invention, lower cost and lower power consumption, as well as very low insertion loss and large power handling capability, can be achieved. In some embodiments, the need for a front end module may be eliminated or relaxed, lowering costs. In some embodiments, the radio frequency transmit/receive switch may be integrated on the same circuit with all or additional parts of the transceiver, such as the low noise amplifier is depicted in FIG. 2. In some embodiments, relatively small, low breakdown voltage (1.5 volts or less), inexpensive, MOSFET transistors may be used to fabricate the switch 10. In some cases, the entire transceiver can be formed using low voltage CMOS technology. However, PMOS transistors may also be used as well. NMOS and PMOS transistors can be used separately or together to implement any of the switches described herein.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. an apparatus comprising:
a low noise amplifier;
an antenna node; and
a transmit/receive switch including a switched parallel resonant circuit in series between the antenna node and the low noise amplifier.

2. The apparatus of claim 1 wherein said parallel resonant circuit includes a parallel inductor and capacitor.

3. The apparatus of claim 2 wherein said parallel resonant circuit includes a switch in series with said capacitor.

4. The apparatus of claim 3 wherein said switch is a metal oxide semiconductor transistor.

5. The apparatus of claim 4 wherein said transistor has a breakdown voltage of about 1.5 volts or less.

6. The apparatus of claim 1 including a shunt switch in parallel with said parallel resonant circuit.

7. The apparatus of claim 6 wherein said shunt switch includes a metal oxide semiconductor transistor.

8. The apparatus of claim 7 wherein said shunt switch transistor has a breakdown voltage of about 1.5 volts or less.

9. The apparatus of claim 1 including a power amplifier and a switch between said antenna node and said power amplifier, said switch having remote body contacts.

10. The apparatus of claim 9 wherein said switch is a metal oxide semiconductor switch having a breakdown voltage of about 1.5 volts or less.

11. The apparatus of claim 1 wherein said apparatus is a transceiver.

12. The apparatus of claim 1 including a DC blocking capacitor between the parallel resonant circuit and the low noise amplifier.

13. A method comprising:
forming a transmit/receive switch using a parallel resonant circuit in series between an antenna node and a low noise amplifier.

14. The method of claim 13 including forming said parallel resonant circuit to include an inductor in parallel with a series coupled capacitor and a switch.

15. The method of claim 14 including forming said switch using a complementary metal oxide semiconductor technology having a breakdown voltage of 1.5 volts or less.

16. The method of claim 13 including providing a shunt switch in parallel with said parallel resonant circuit.

17. The method of claim 16 including forming said shunt switch of a metal oxide semiconductor transistor with a breakdown voltage of about 1.5 volts or less.

18. The method of claim 13 including providing a power amplifier and providing a switch between said antenna node and said power amplifier, said switch having remote body contacts.

19. The method of claim 18 including using a metal oxide semiconductor transistor as said switch, said transistor having a breakdown voltage of about 1.5 volts or less.

20. The method of claim 1 including forming said parallel resonant circuit using an inductor, that is part of the parallel resonant circuit and which also acts as the input matching inductor for the low noise amplifier.
